(19) United States
(12) Patent Application Publication
(10) Pub. No.: US 2023/0011200 A1
(43) Pub. Date: Jan. 12, 2023

(54) CONVERTING VARIABLE RENEWABLE ENERGY TO CONSTANT FREQUENCY ELECTRICITY BY A VOLTAGE REGULATED SPEED CONVERTER, A VOLTAGE-CONTROLLED MOTOR GENERATOR SET OR A VOLTAGE CONVERTER

(71) Applicant: Differential Dynamics Corporation, Owings Mills, MD (US)

(72) Inventor: Kyung Soo Han, Timonimum, MD (US)

(21) Appl. No.: 17/666,985

(22) Filed: Feb. 8, 2022

Related U.S. Application Data
(60) Provisional application No. 63/219,579, filed on Jul. 8, 2021.
(60) Provisional application No. 63/295,075, filed on Dec. 30, 2021.

(51) Int. Cl. F03D 9/00; H02P 9/04; G05F 1/12; H02J 3/38; F03B 1/00; F03D 9/25; F03D 15/00; F03D 7/02

(52) U.S. Cl. CPC F03D 9/008; H02P 9/04; G05F 1/12; H02J 3/381; F03B 1/00; F03D 9/25; F03D 15/00; F03D 7/0276; H02P 2101/10

(57) ABSTRACT

A river, tidal, wave or ocean current turbine, a wind turbine or a solar panel harnesses an optimum value of renewable energy from variable water flow or wind flow or from electromagnetic energy from sunlight harnessed by photovoltaic conversion to electricity. A harnessing module comprising a propeller facing, for example, water or wind flow and a generator driven by the propeller, thus may harness variable electric power from water (or wind) renewable energy and may be preferably connected to feedforward electricity source and preferably a feedback variable electrical load to an electrical voltage regulator apparatus of a land module and to a motor generator set or voltage converter by a flexible electrical cable for receiving a variable rotational speed converted to variable electrical frequency, the voltage regulator automatically providing a predetermined minimum electrical power/voltage output at constant frequency to the motor generator set or a voltage converter and output at constant frequency to a constantly varying grid load. The variable electrical input from harnessing modules is delivered to the voltage regulator and converted to a constant electrical frequency by the motor generator set. In alternative embodiments, the voltage regulator is replaced by a voltage regulator in series with a servo motor and a variable voltage transformer and, in a third embodiment, the voltage regulator is replaced by a power converter.

This application claims the right of priority to U.S. Provisional Patent Application Ser. No. 63/219,579 entitled “Converting Variable Renewable Energy to Constant Frequency Electricity by a Voltage Regulated Speed Converter,” filed Jul. 8, 2021, and to U.S. Provisional Patent Application Ser. No. 63/295,075 entitled “Converting Variable Renewable Energy to Constant Frequency Electricity by a Voltage-Controlled Motor Generator Set or a Power Converter,” filed Dec. 30, 2021, both patent applications being of the same inventor, Kyung Soo Han, and both patent applications incorporated by reference herein in their entirety.

### TECHNICAL FIELD

The technical field of the invention relates to providing a method and apparatus for controlling the harnessing of wind, water flow, geothermal or thermal and solar renewable energy to constant frequency electricity output of a generator or a motor generator set for feeding a variable load by use of a voltage regulator with electrical inputs from a harnessing module delivering a feedforward harnessed variable electrical voltage and/or a feedback voltage from the variable load fed by the generator to a voltage regulator of a speed converter. Any electricity generator may have multiple sets of poles added radially or axially. Any number of harnessing modules (wind, water, wave, ocean current, geothermal or thermal) may be series or parallel connected to a voltage regulator-controlled speed converter located on land. A voltage regulator (alternatively using a variable voltage transformer) may regulate variable harnessing module voltage via a motor generator set with a feedback variable voltage value to the voltage regulator. A power converter (from the art of wind turbines) may also regulate delivery of constant frequency to service a grid having a variable load for feedback.

### BACKGROUND OF THE INVENTION

Referring to prior art FIG. 1 of the present patent application, there is shown a comparison 100 of various forms of renewable and thermal energy and their relative percentages of growth between 2016 and 2019. Renewables include hydroelectric (hydro) whose use has grown to 6.6% in 2019 from 6.0% in 2016. Wind has grown from 6.0% to 7.3%. Solar has grown from 1.0% to 1.8%. Biomass has decreased from 2.0% to 1.4% while geothermal has remained constant at 0.4%. This chart of renewable energy does not show what is known as hydrokinetic energy which may be derived from river flow, ocean currents, tidal tributaries, ocean waves and the like.

FIG. 1 also shows a decline in growth of so-called thermal energy (except natural gas) over the same period between 2016 and 2019. Coal-fueled turbines and other uses of coal for electricity generation have dropped from 30% to 23% while use of natural gas has increased from 34% to 38% and nuclear power and oil has remained constant at 20% and 1% respectively. Thermal has the known problems: coal, oil and natural gas have carbon emissions which can deplete the ozone layer and increase risks to the environment. Coal, oil and natural gas are resources that are being depleted and cannot be reproduced. Coal, natural gas and oil are not immediately renewable resources. Nuclear reactors produce spent reactor rods that must be disposed of and have half-lives of hundreds of years and so must be buried or otherwise placed out of reach of the populations of countries using nuclear reactors.

Prior art FIG. 2 of the present patent application diagrams frequency generation and regulation 200 striving for a constant frequency of electric power during such events as a sudden loss of power generation or a sudden drop or increase in load of a supplied electrical grid. FIG. 2 uses an example of a water system having an input port of electricity, a variable depth pot of electricity and a spigot to demonstrate that constant frequency electricity output to a load of an electricity grid must be regulated to within ±0.02 Hz. Under Generation 210, it reads frequency range during normal operation; this frequency range from 59.98 Hz to 60.02 Hz (US) is a reasonable electrical frequency range (US). If the US frequency range deviates ±0.02 Hz, and is frequently corrected, electric clocks will tell the correct time. Events such as a sudden loss of electricity generation or distribution or a sudden variation in load may require immediate resolution, for example, by under-frequency load shedding or under-frequency generation tripping. Prior art FIG. 2 shows a frequency range of electricity generation which is an abnormal frequency range which may be caused by a sudden loss of generation, for example, from 59.70 Hz to 60.02 Hz (US) and must be corrected to within ±0.02 Hz. Under or over constant frequency 60 Hz (US) may be delivered to a variable load 220 in sudden loss or gain situations for an electric grid between 59.70 Hz to 60.02 Hz during abnormal generation and overload conditions but not in normal conditions. Whole neighborhoods of a city may be switched off-line during sudden generation loss remedied by load shedding or generation tripping. Examples include excessively hot days when air conditioning is using power and whole parts of a city such as New York City may be blacked out.

Renewable energy harnessing modules or associated generators and output generators may fail. The harnessing modules may lose wind flow on quiet days, and sunlight for activating solar panels does not shine during the night. Whether the constant frequency is 50 Hz (Europe), 60 Hz (US) or 400 Hz (aircraft), the constant frequency must be maintained within close tolerances. For example, an electric clock requires 60 Hz (US) to maintain correct time. Power generation 210 must balance load 220 and electric frequency be as constant as possible and close to 60 Hz (US) at all times.

U.S. Pat. No. 10,815,968 issued Oct. 27, 2020, of inventor Kyung Soo Han, incorporated by reference as to its entire contents, describes a waterwheel harnessing module of “concentric wings” for harnessing water flow energy as an example of harnessing water flow renewable energy efficiently. A large propeller is typically used for harnessing wind energy while a small propeller is used for hydrokinetic power generation. In prior patent applications of Kyung Soo Han, a waterwheel having a closable hatch under control of spur gear assemblies was used to regulate the capture of water flow renewable energy from rivers. The concentric wing waterwheel water flow is not regulated by a hatch and is perhaps the most effective waterwheel for driving a generator via a common shaft, and, also, pitch control for a wind propeller harnessing module is not presently used by Kyung Soo Han for regulating speed of a wind or water propeller harnessing module but is part of the prior art. On the other hand, a variable speed to constant speed converter including first and second three variable transgear speed converters (spur or helical, bevel or miter and ring gear assemblies) and power converters or speed converters are known for use in wind turbines. This form of energy harnessing module is shown in prior art FIG. 3.

Referring to prior art FIG. 3, an underwater concentric wing waterwheel 304-1 converts renewable river flow energy from the left via a common shaft 306 to a generator 308 which outputs variable electricity at variable frequency via electrical cable 315. Energy harnessing module 320 is a harnessing module that harnesses electrical power because it delivers variable electricity via renewable water energy turning a waterwheel 304-1 or having a propeller 304-Z and the generator 308 delivers variable electricity by electrical cable 315 to an input motor 325 for turning the common input shaft 349 of first and second three variable ring gear assemblies 345-1 and 345-2. The electrical cable 315 also branches at terminal 341 and cable 330 delivers the variable alternating current and frequency electricity to a voltage regulator 335 for regulating a control voltage. A controlled voltage is output by voltage regulator 335 on cable 343 for operating control motor 340 to provide frequency control via shaft 347 and control gear 347-1 to control first and second three variable ring gear assemblies 345-1 and 345-2 to provide a constant rotational speed of output shaft 357 via output gear 357-1 to deliver constant frequency of electric power via output generator 350 to a grid 360 assuming a constant load. Whether the constant frequency is 50 Hz, 60 Hz or 400 Hz, there is shown the necessary process of “frequency regulation” to maintain a constant frequency of alternating current wherever one is in the world so long as the load 360 remains constant ±0.2 percent.

Referring again to prior art FIG. 3 of the present application, International Publication No. WO 2020/139863A1 (the '863 published application), published Jul. 2, 2020, of Kyung Soo Han, incorporated by reference as to its entire contents, shows a first and second three variable ring gear assembly, harnessing module, input generator, control motor, voltage regulator and output electricity generator in FIGS. 10C, 17, 23A through 23C and 26. A typical input rotational speed provided by a river flow harnessing module comprising a constant rotational speed value X plus a variable rotational speed component Δ. Referring to FIG. 17, a constant rotational speed input X of 1800 rpm plus the variable rotational speed component Δ rpm is converted to 2X or a constant rotational speed of 3600 rpm at the output. A transgear assembly rule may permit an input rotational speed of X result in an output rotational speed of generator 450 to range from zero to at least 3600 rpm or 2X. Referring to FIG. 3 of the present application, first and second three variable ring gear assemblies 345-1, 345-2, with, for example, the concentric wing harnessing module (304, 306, 308) (which may be part of any renewable water or wind energy harnessing module) provide the bulk of renewable electrical energy to the input motor 325 via an electrical cable 315 to the input motor 325. A branch cable 330 from terminal 341 delivers a variable voltage at variable frequency to a voltage regulator 335 that is the same value as is supplied to a control motor 340. A land module separated by a horizontal line from a river flow energy harnessing module 320 may be located proximate one or more other water/wind renewable energy harnessing modules, wind turbines and solar panel sources of renewable energy and thermal sources and so processed by land module 310 comprising control 340 and generator 350. The voltage regulator assures voltage regulation of the voltage and electrical frequency delivered to control motor 340. First and second three variable ring gear assemblies 345-1, 345-2 may be replaced by first and second three variable spur or helical gear assemblies or by first and second three variable bevel or miter gear assemblies of FIGS. 10A and 10B of the '863 published application.

Generation must balance load in this prior art example following prior art FIG. 2, but it does not meet a ±0.02 Hz range at 60 Hz (US). If frequency drops, for example, below 60 Hz, all the clocks depending on constant frequency electric power will show the incorrect time of day. Under frequency is corrected by load 220 shedding or generation 210 tripping. Deviations from, for example, 60 Hz frequency may lead to corrective actions that may threaten the reliability of the power grid such as a deviation from constant frequency of only ±0.02 Hz deviation from a constant value such as 60 Hz (US).

Referring again to prior art FIG. 3, International Publication No. WO 2020/139863A1, published Jul. 2, 2020, of Kyung Soo Han, incorporated by reference as to its entire contents, shows enhancing a first and second three variable ring gear assemblies with, for example, a concentric wing harnessing module (which may be part of any renewable water energy harnessing module) providing renewable electrical energy to the input motor 325 via an electrical cable 315 to the input motor 325. A branch cable 330 from a terminal 341 delivers a sample value of voltage to a voltage regulator 335 from the underwater energy harnessing module 304, 306, 308 that is the same value as is supplied to the electrical cable 315 to an input motor 325. The sample feedforward voltage regulates a voltage supplied by cable 343 to a control motor 340. A land module separated by a horizontal line from a water power harnessing module 304, 306, 308 may be located proximate one or more other water flow renewable energy harnessing modules, wind turbines and solar panel sources of renewable energy.

In further prior patent applications of Kyung Soo Han, a waterwheel having a closable hatch under control of spur gear assemblies was used to regulate the capture of water flow renewable energy from rivers. The concentric wing waterwheel water flow is not regulated by a hatch, and, also, pitch control for a wind propeller harnessing module is not presently used by Kyung Soo Han for regulating speed of a wind propeller harnessing module but is part of the prior art. On the other hand, a variable speed to constant speed converter including at least one three variable spur or helical, bevel or miter or ring gear assembly is known for use in wind or water flow turbines.

Referring to prior art FIG. 4, there is shown a known motor generator set or MG Set 400 comprising a constant rotational speed motor 425 and a generator 450 of the motor generator set 400 having constant electrical frequency output (50 Hz European, 60 Hz US or 400 Hz aircraft) may be used to deliver electrical power at constant frequency to a grid having a constant (or variable) load. The variable rotational speed may be a multiple of the constant frequency or a fraction (for example, for 400 Hz). The generator 450 driven by motor 425 of such a motor generator set may produce any desired constant frequency at its output: 50 Hz, 60 Hz or 400 Hz shown in a separate table of motor/generator and table 410, FIG. 4. Prior Art.

When the load is constant, the variable renewable energy received from a harnessing module used in generating hydrokinetic electric power from its mechanical speed may be regulated to a constant speed by a known voltage regulator 335. Referring again to prior art FIG. 3, a grid 360 powered by the generator 350 of a motor equivalent generator set may be a micro-grid, a collection of micro-grids or a large regional electrical grid. The input motor 325 to the generator 350 may receive a variable renewable electric energy from an energy harnessing module: waterwheel 304-1, shaft 306, generator 308 comprising a propeller 304-2 and a generator 308 on a river bottom (or below the water line). The land-based mechanical speed converter device (ring gear assemblies 345-1, 345-2 shown as alternatives to spur or helical gear or bevel or miter gear transgear assemblies) may be a mechanical, three variable gear assembly: common shaft input variable, control motor control variable and output generator (not fed back for an output control variable). A three variable transgear gear assembly with input, control and output variables is much like a transistor.

A typical “motor equivalent” to a “motor” of a motor generator set or MG Set may be an energy harnessing module having a propeller or waterwheel 304-1 facing river flow direction and generator 308, and energy controlling land module 310 except generator 350 comprises input motor 325, voltage regulator 335, control motor 340 and, for example, first and second three variable ring gear assemblies 345-1 and 345-2. A generator 350 of “motor equivalent” generator set or MEG set outputs a varying level of constant frequency electricity depending on the flow rate of the river, tidal current or ocean current. Wind turbines may use the same principles as are used in hydrokinetic river turbines to convert variable electric power to constant frequency electric power output. As is known, a wind may blow all night, but the sun shines only during the day. Solar panels, in other applications, with back-up generator use, may use banks of batteries to run an input motor when the sun does not shine at night. A principle of a known motor generator set or MG set of prior art FIG. 4 is that the input motor 425 is operated at constant speed to generate constant frequency electric power at generator 450 to a constant grid 360 or load not shown. A principle of a “motor equivalent” generator set or MEG set is that the harnessed variable mechanical renewable power is converted to constant rotational speed by the “motor equivalent” so that the rotational speed of the generator shaft 357 (FIG. 3) is constant to generate constant frequency electricity.

U.S. Pat. No. 11,111,898 (the '898 patent) issued Sep. 7, 2021, from U.S. patent application Ser. No. 17/012,426, filed Sep. 4, 2020, by Kyung Soo Han, is incorporated by reference as to its entire contents. A first enclosed chamber may contain a first and second three variable speed converter and a second enclosed chamber may contain a different first and second three variable speed converter. FIGS. 9A, 9B, 9C, 10C and 10D of the '898 patent show examples of an energy harnessing module that produces a variable voltage and variable frequency electric power such as a concentric wing waterwheel and generator (which could be, equally, a wind flow harnessing module or other water flow harnessing module). The apparatus via feedback from the load (FIGS. 10A and 10B) to a voltage regulator may selectively provide a constant electrical frequency output, for example, 50 Hz, 60 Hz or 400 Hz via an output generator to a variable load.

An embodiment of a power controlling module on land may be powered by storage batteries for storing excess generated DC power. U.S. patent application Ser. No. 15/707,138 filed Sep. 18, 2017, now U.S. Pat. No. 10,378,506 issued Aug. 13, 2019, to Kyung Soo Han and incorporated by reference as to its entire contents suggests a commutator-less and brush-less direct current generator that is more efficient than known DC generators and may be used to generate direct current power for a control motor or a control motor that may operate with alternating current.

Rather than a constant speed, a “motor equivalent” may receive a variable power or rotational speed due to variations in water or wind flow and direction. A control motor 340 of prior art FIG. 3 is designed to supply a control rotational output speed (or no speed) to control the input rotational speed via gear 347-1 to constant rotational speed for output to generator 350 and constant frequency grid 360.

Solar panels generate renewable energy when there is sun light and no electricity when there is no sun (during night). A “motor equivalent” may be a renewable energy harnessing module such as a waterwheel or propeller (water or wind flow) or a concentric wing driven by water at variable speed (because air or water are at variable speed and direction) or a solar panel. The known “motor equivalent” may comprise an energy harnessing module coupled with a mechanical speed converter to deliver constant speed so that the output of the generator outputs at constant electrical frequency to a constant load. The “motor equivalent” converts variable power to a constant rotational speed and delivery to a generator which outputs electricity at constant frequency.

Water flows at variable speed and direction (tidal flow, for example) and so does wind. The sun only is bright enough during daytime hours for conversion to electrical energy. An advantage of water flow is the mass/density, inertia or power that may be generated by the flow of water compared with the flow of wind (wind amounts to 6% or renewable energy sources) where wind may be harnessed by large wind-driven propellers or rotor blades. Also, for example, river water typically flows at all hours of the day at a relatively constant rate of flow while wind energy and direction may vary from one minute to the next.

Referring again to prior art FIG. 1, hydroelectric power is generated by a dam. A dam is expensive to build, and USA hydroelectric power plants produce approximately 6.6% of electric energy (in 2019). A hydroelectric power plant may be considered an example of a “motor equivalent” generator set (ME-G set or MEG Set). Typically, a river flow stopped by a dam initially provides potential energy as the dam stops river flow. The dam builds a backed-up water reservoir to a selectable depth D between a reservoir and an intake gate (one of many). Its associated penstock channels the potential energy from the depth D of water back-up into variable kinetic energy as it flows through the penstock. The water flows through a penstock to run a turbine generator located in a powerhouse as the water flow achieves different depths D of potential energy of water during rainy seasons or the dam's water flow is stopped when depth D is low (drought).

The Grand Coulee dam, Hoover dam and the Tennessee Valley Authority are exemplary of projects started in the early 20^{th} century in the United States for generating hydroelectric power, but these require large dams to build potential energy for turning electric turbine generators. Another example of a hydroelectric power plant is the Supung dam on the Yalu River bordering China and North Korea. An algorithm of a hydro power plant demonstrating three variable control is that river energy=a minimum value X+Δ, a variable value comprising a constant minimum constant rotational operating speed X plus a desirable variable value Δ depending on the water flow speed of the river stopped by the dam and run through turbines to generate electricity. The spillway and wicket gate-controlled power to a turbine/generator=the reservoir potential energy+the spillways and wicket gates (control) or (X+Δ)+Δ=X, the minimum power generated. The Supung dam in Korea boasts twenty-six main sluice gates and sixteen auxiliary sluice gates with an installed capacity of 765 megawatts. (1) Input water flow through each penstock at depth D, (2) determines potential energy which is converted to kinetic energy by generator turbines, (3) create hydrokinetic power, and (4) output is a continuation of water outflow of the Yalu river. Large hydroelectric generators in such dams on rivers in the United States are now being replaced with more efficient and larger capacity turbines and generators. But the number and utility of dam-based hydroelectric power is limited and the number has not grown since the 1980's. Also, the dams block migrating fish and commercial river traffic on navigable rivers. The dam backs up a river to form a lake which can take away valuable land resources that could be used to grow food or permit animals to feed. On the other hand, the created lake provides water control and recreational use for boating, fishing and the like.

Known marine hydrokinetic (MHK) turbines such as run-of-the-river, tidal, ocean and hydrokinetic river turbines and wind turbines have some problems. There is the problem of having to convert a harnessed variable power (water or wind) to a constant frequency and dependable power output. On the other hand, there are many advantages for harnessing marine hydrokinetic (MHK) over wind energy: for example, the density (mass or inertia) of water is much greater than that of wind. Water flow speed is not as variable as wind speed especially when a river constantly flows in the same flow direction (such as the Mississippi River of the United States). Tides are reversible (high tide to low tide flowing toward the ocean and low tide to high tide flowing in from the ocean). Associated known tidal turbines may be limited to generating power in one direction of water flow (during changing high to low tide or low to high tide) and generate maximum power at only two high and low tide changes during a day and so resultant output power is sinusoidal in nature (water flowing in until a maximum speed is reached and then reversing and flowing out until a maximum speed is reached).

Historically, water and wind renewable energy has relied on one of the many variables in order to produce electric energy at constant electrical frequency. A problem in the prior art is that an emphasis has been placed on control by rotational speed (harnessing module and generator output), torque (applied by river/water flow or to a generator shaft), frequency (electrical frequency) and input and output power ratio. A problem with reliance on these variables is that voltage and voltage regulation is overlooked or ignored as a key factor at input from a renewable energy harnessing module to be applied to a variable load and grid.

Consequently, there remains a need in the art to provide applications of an energy conserving harnessing module, a speed converter with feedback from a variable load and a known motor generator set or voltage converter that can produce more baseload power in combination with a hydrokinetic, wind turbine or collection of solar panels to provide a variable value of power at a constant frequency (within ±0.02 Hz (US)) which can receive feedback voltage from a variable load of a grid and, if necessary, a known feedforward variable voltage from the energy harnessing module.

### SUMMARY OF THE PREFERRED EMBODIMENTS

Embodiments of control systems for renewable energy electric power generation at constant frequency may involve the combination of first and second three variable spur or helical gear assemblies, bevel or miter gear assemblies and ring gear assemblies such as dual spur gear, dual bevel gear or dual ring gear speed converter gear assemblies having a voltage input from generator 308 of a wind or water renewable energy harnessing module 320 that is fed to both an input motor 325 and a voltage regulator 335. The voltage regulator 335 in a known embodiment thus receives a variable fed-forward value of voltage output by the wind/water energy harnessing module 320 (or multiple wind/water harnessing modules). After many iterations of designs of mechanical speed converters, the present invention suggests a motor generator set (MG Set) with a voltage converter may which replaces the need for a mechanical speed converter when electrical power is harnessed.

A concept in motion control technology is introduced in the present invention that is founded on the development of three variable building blocks using motor generator sets. (See prior art FIG. 4 for a known motor generator set). A known motor generator set automatically converts variable rotational speed in rpm to a desired constant electrical frequency at the generator electrical output of the motor generator set. Three variable gear assemblies called speed converters (variable to approximately constant speed converters) control speed, torque or power output independently and infinitely. A first concept built from such speed converters in a so-called controlling and generating module whose algorithm is: (1) input is the variable renewable energy harnessed by the harnessing module discussed above (typically, wind or water), (2) convert the variable energy to constant speed, (3) generate constant frequency from the constant rotational speed input to a common speed converter shaft or to a motor generator set or voltage converter, and (4) continuously adjust any variation in frequency that is caused by a variable electrical load to constant frequency by a simple feedback control based on feedback from the variable electric load. With use of a specially designed speed converter, a known “motor equivalent” generator set (MEG set) with a voltage converter, feed forward voltage may regulate the variable input power due to variable harnessed renewable energy, and feedback voltage may regulate the variable electric power frequency due to a variable load of an electric grid. The direct connection of the motor to the generator of the motor-generator set automatically sets the output electric frequency to constant frequency because the motor is directly connected to the generator by a common shaft and the motor's constant rotational speed is converted to the desired constant frequency output.

A first embodiment of a voltage regulated motor generator set or “motor equivalent” generator set or MEG set may utilize a known propeller/generator of, for example, a river, tidal or an ocean current hydrokinetic turbine that is tied by an electric cable to a land-based voltage regulated motor equivalent generator set. The electric cable depending on the source of water or wind energy called a harnessing module connects the harnessing module under water or on a windy hill to a land-based voltage regulator and motor equivalent generator set that may be shared by other renewable energy sources by connection using another flexible cable. The land-based motor equivalent generator set (may be a controlling and generating (C&G) module) should be as close to the wind, water or solar-based harnessing module so as to limit the loss of electric power by the electric cable connecting the harnessing module and C&G module. On the other hand, the only feedback required for operating this land-based module comprising a motor equivalent generator set or voltage converter comes from the baseload voltage value used by the grid at variable load frequency which is fed to the voltage regulator along with the variable voltage output of the wind or water harnessing module (only if necessary and not shown).

A second embodiment of a voltage regulated motor equivalent generator set replaces a single voltage regulator with a voltage regulator responsive to variable grid voltage value connected in series with a servo motor and the servo motor connected to a variable voltage transformer (VVT). The voltage regulator is also for the purpose of controlling the feedback voltage input from an electric power grid whose voltage may vary as load may increase and decrease at all hours of the day. The servo motor is run by the voltage output of the voltage regulator and outputs a mechanical rotational speed output to the central core of the variable voltage transformer (VVT). The variable voltage transformer receives the electrical output of the harnessing module/generator and is controlled to produce a predetermined value of output frequency of, for example, 60 Hz (US).

A third embodiment may use a motor generator set controlled by a power converter known in the field of wind turbines. A known embodiment of such a power converter is capable of converting up to sixteen megawatts (as of today) of variable electrical power output from a vertical or horizontal wind turbine to constant frequency baseload power for delivery to a grid load. A voltage converter may replace the power converter known in the art of wind turbines and assume all the functions served by the first embodiment and second embodiment discussed above. In a hydrokinetic environment, the voltage converter or motor generator set or “motor equivalent” generator set will be land-based and receive variable electric power at variable frequency from, for example, an underwater propeller and generator via a flexible electric cable. The voltage converter or motor generator set or “motor equivalent” generator set may receive variable frequency feedback for correction to constant, for example, 60 Hz (US) only from a variable load and deliver constant frequency electric power having converted the power from the underwater propeller and generator.

Thus, while there remains a need in the art for automatically adaptable voltage and frequency regulation so that baseload power may be increased or decreased depending on wind or water harnessing module electric capacity for generating electricity and on variable load voltage requirements, for example, via a mechanical or electrical connection to a land-based controlling and generating module, the first and second embodiments of a motor generator set and third embodiment utilizing a voltage converter, the three embodiments utilizing feedforward input from a harnessing module generator to a voltage regulator or to a variable voltage transformer and other speed converter embodiments will be described with respect to the drawings, a brief description of which follows.

### BRIEF DESCRIPTION OF THE DRAWINGS

Prior art FIG. 1 shows a comparison between 2016 and 2019 usages of renewable energy and a diminishing use of thermal energy generation through coal (excluding natural gas) and the disadvantages of nuclear reactors and the emissions of thermal energy sources including, coal heating oil and natural gas which adversely impact our environment. Renewable energy shows a favorable increase in hydroelectric power, wind and solar (geothermal remains constant at 0.4% and biomass shows a decrease from 2.0% to 1.4%. Coal (a thermal source) shows a loss from 30% in 2016 to 23% in 2019; natural gas rises from 34% to 38% and nuclear at 20% and oil at 1% stay constant.

Prior art FIG. 2 comprises an example 200 of the importance of electrical frequency regulation to a predetermined constant value such as 60 Hz (USA). The example shown is analogous to a water pot having an input spout at generation 210 and a load spigot 220 for variable load. During the generation 210 of electric power, a normal frequency range is within a ±0.02 Hz deviation from a constant value such as 60 Hz. Load 220 more severely impacts constant frequency and may result in frequency control actions such as load shedding and generation tripping. The figure is suggesting that frequency generation may be normal with a range from 59.50 Hz to 60.02 Hz and that constant frequency must be closely maintained between ±0.02 Hz otherwise electric power clocks would not show the proper time of day. With a sudden loss of generation 210 constant predetermined frequency such as 60 Hz may drop to unacceptable levels and threaten the viability of the power grid which generation 210 must serve.

Prior art FIG. 3 shows the use 300 of a harnessing module 320 and controlling and generating module 310 comprising, for example, land-based first and second three variable ring gear assemblies 345-1, 345-2, with an underwater energy harnessing module 320: waterwheel 304, shaft 306, generator 308 taken from patents and a patent application described above where an output electricity generator 350 may output a constant rotational speed for running the output electricity generator at a desired predetermined constant frequency which may be 50 Hz, 60 Hz or 400 Hz or other value shown in a separate table of motor/generator 425, 450 and associated table shown in FIG. 4, Prior Art. The variable input of the rotational speed energy of the harnessing module and the output electricity frequency is monitored but requires regulation to attempt to achieve a constant frequency output at output generator 350. The question of how to generate constant electrical frequency is to utilize a motor generator set or mechanical rotary frequency converter with feedback monitoring such that a constant speed control motor 340 may generate a constant desired frequency, for example, 50 Hz, 60 Hz or 400 Hz which question remains unanswered as an output variable generator 350 output remains un-monitored for feedback to a first and second three variable ring gear assembly with input variable from input motor 325 of variable frequency and voltage controlled by control motor variable of control motor 340 for monitoring energy harnessing module 304, 306, 308 and an un-monitored output generator 350 voltage or frequency which will vary with variable load conditions.

Referring again to prior art FIG. 3, when a controlling and generating module 310 or a speed converter is driven by a variable power, variable voltage is regulated only by a voltage regulator 335 receiving feed forward variable voltage from generator 308 at variable frequency from renewable energy harnessing module 320. Depending on the variable voltage received from generator 308 via terminal 341 and electric cable extension 330, voltage regulator 335 will output a control voltage on cable 343 to control motor 340. Control motor 340 converts the control voltage to a variable control rotational speed of control shaft 347 and gear 347-1 thus controlling the variable speed of input shaft 349 to a constant rotational speed when, per 360, “Grid: Constant Load,” the load is constant and so able to deliver a constant frequency. The voltage regulator 335 will process the full load from harnessed feedforward voltage from the energy harnessing module 304, 306, 308.

Prior art FIG. 4 shows a first embodiment 400 of a known motor generator set or MG Set comprising motor 425 and generator 450 tied by a common input shaft for receiving the rotational speed output in rpm of the motor 425, wherein a water or wind energy harnessing module typically for wind or water energy involves a propeller pointing into the wind or the direction of water flow with a variable voltage and frequency output and may be input to the motor generator set via voltage regulation to provide constant frequency input. A motor generator set 400 is known where the motor 425 automatically outputs a constant rotational speed via a common shaft to a generator 450 for deriving a desired constant frequency output at 50 Hz (European), 60 Hz (US) and 400 Hz (aircraft) per table 410. The rotational output of a propeller turning a generator of an energy harnessing module is responsive to variable water (or wind) flow. The variable water (or wind) flow generates an electrical voltage of variable frequency and variable value depending on the wind or water velocity which may vary as the weather varies or with solar panels when the sun shines.

FIG. 5 shows a first embodiment of the present invention comprising a land-based controlling and generating module combined with a water or wind energy harnessing module 520 typically for wind or water energy. A waterwheel 504-1 points into the variable wind flow or the direction of variable water flow. Therefore, the output of waterwheel 504-1 turns a shaft operating generator 508 at a variable electrical voltage of variable frequency depending on the wind or water velocity which may vary as the weather varies. When a first and second three variable speed converter such as one comprising first and second ring gear assemblies is provided, feedback variable voltage and variable frequency values may be regulated by a voltage regulator 535. FIG. 5 is an example of a speed converter with ring gear transgear assemblies 545-1, 545-2 wherein a voltage regulator 535 may receive the feed forward value of electric voltage presently generated by the harnessing module (which may be a wind turbine comprising a propeller 504-2 and generator 508 outputting variable frequency and electricity on alternate electric cable 541-2). Feedback voltage from variable load 565 is received at voltage regulator 535 to output a control voltage to control motor 540 so that generator 550 may output constant frequency to micro-grid 560. Power used by the micro-grid (grid) 560 initiates with the variable renewable mechanical energy harnessed by the harnessing module 520 which provides a variable voltage output of energy harnessing module 520 to a shared voltage regulator 535. The output electric power from generator 508 powers input motor 525 and also control motor 540 via voltage regulator 535. More power generation by a multiple pole generator per FIGS. 6B (radial addition of eight sets of three poles) and 6C (axial addition of four sets of three poles) is possible by increasing the circular diameter 602-4 or the length 602-5 of a generator 508 or 550. Also, more power generation is possible using a known variable overlap generator (VOG) by increasing the overlap of the stator and the rotor.

FIG. 6A (Prior Art), and FIGS. 6B and 6C (both new) show a further embodiment of the present invention wherein a variation in the number of poles of a known generator 602-1 (FIG. 6A) is varied from, for example, three poles to a multiple of poles added radially or axially. More particularly, FIG. 6B is an example of adding eight multiple sets of three poles each radially so that the same generator 602-3 (side view), 602-4 (cut view), generator 602-3 in side view may have a large diameter having the same diameter as cut view 602-4 and having a circular shape. FIG. 6C is an example of adding four multiple sets of three poles each axially (along the common shaft of the generator 602-5) so that in side view 602-6 there is a circular shape. FIGS. 6B and 6C may be used together such that a generator may comprise both multiple sets of poles added radially and axially

FIG. 7 shows a fourth embodiment 700 of the present invention comprising a land-based module combined with, by way of example, three underwater hydrokinetic turbines 720-1, 720-2 and 720-3 (any number may be connected in series or in parallel, for example in a river) connected, for example, to operate in a length of river in series for harnessing river energy. A land-based control and generating module (C&G module) comprises first and second three variable ring gear assemblies 745-1 and 745-2 wherein a water harnessing module 720-1 (or wind energy harnessing module (not shown)) typically for harnessing water flow mechanical energy involves a concentric waterwheel 704-1 pointing into the direction of water flow or a propeller pointing into the wind flow with direction, for example, determined by a wind vane. The output of a propeller turning a generator or a hydrokinetic turbine is an electrical voltage of variable frequency and variable value depending on the wind or water velocity which may vary as the weather varies. A power converter 1280 (see FIG. 12) is known from the art of wind turbines and converts a variable output rotational speed of a wind propeller of a vertical or horizontal axis wind turbine to constant frequency output to a micro-grid (grid) 760, the grid 760 is tapped to provide a grid load value at a given point in time so that a hydrokinetic turbine or a wind turbine may convert a waterwheel or a wind propeller rotational speed driving a generator to output variable power at variable frequency to output constant frequency to match variable grid load 765. FIG. 7, by way of example, shows three hydrokinetic turbines 720-1, 720-2 and 720-3 having electrical cables for carrying the individual electricity outputs of the three hydrokinetic turbines to a summer (junction box) 723 where, actually, any number of different renewable energy harnessing module outputs may be summed at summer (junction box) 723 and delivered at terminal 741 to a voltage regulator 735 along with electric power generated by output electricity generator 750 and delivered to variable load 765 via terminal 751. The voltage regulator 735 receives feed forward from summer 723 and feedback from variable load 765 and outputs a control voltage for operating control motor 740 to deliver a controlled speed via shaft 747 and shaft sun gear 756 to the first ring gear 745-1 as a control of input variable frequency and electricity value received at input motor 725 from summer (junction box) 723.

FIG. 8, by way of example, shows an embodiment 800 comprising a controlling and generating module combined with three wind turbines 804-1, 806-1, 808-1 whose outputs may be combined from three axially connected generators and supplied to one or more summers (junction boxes) 883 (summer 883 shown). Summer 883 outputs the summation of all electricity inputs of variable frequency and electrical power to terminal 841 delivering input power to input motor 825 and to voltage regulator 835 which outputs a regulated voltage for controlling control motor 840 to deliver a control variable to the first three variable ring gear assembly. The output of output electricity generator 850 is output to transformer 870 and to grid 860 at constant frequency. Because wind power is intermittent, electric power output is typically sent directly to the grid 860. If other more consistent power is provided by, for example, marine hydrokinetic turbines, then a feedback path to voltage regulator 835 is used as seen in FIG. 7.

FIG. 9, by way of example, shows an embodiment 900 of the present invention involving the consolidation of a plurality of different renewable energy harnessing modules from 908 to 920 which may have different characteristic features in terms of harnessing renewable energy. For example, a solar panel 920 may gather sunlight and convert the sunlight via photovoltaic converter integrated circuits directly to electricity. On the other hand, sunlight only shines during the day. Ten different solar panels are shown by electrical leads 925-1 through 925-10 reaching electrical junction box 923. Vertical-axis wind turbines are represented by turbine 918 with electrical lead 915-2 to junction box 923. Horizontal-axis wind turbines are represented by turbine 916 comprising a propeller that faces the wind and output power generator of variable electric power and variable frequency. Many wind turbines face idle wind periods when no power is generated. A hydrokinetic river turbine 908 is represented by a combination of waterwheel 904-1 and generator 908-1 is typically active at all times of the day except when there are severe drought conditions or the river where the turbine is located freezes the waterwheel components. A tidal turbine is represented by tidal turbine 910 which operates in a tidal estuary during high and low tides, but not when the tide is changing. Wave turbine 912 operates when waves reach peak activity such as during severe storms but not calm seas. Ocean current turbine 914 (waterwheel 914-1 and generator 918-1) can operate at all hours of the day within an ocean current that is natural to the given ocean in which the current runs. These renewable sources may be combined with thermal sources (coal, natural gas, nuclear, oil, geothermal) to provide a more constant source of baseload electricity. FIG. 9 is dedicated to renewable energy sources such that electrical junction box 923 delivers electricity from varying sources of renewable energy to a controlling and generating module located typically on land having a voltage regulator 935 for receiving feed forward energy from harnessing modules 908 through 920 and feedback from variable load 965 of output electricity generator 950 to provide a control variable via control motor 985.

FIG. 10 shows an embodiment 1000 of the invention involving a top view of an onshore or offshore wind turbine or underwater hydrokinetic turbine shown comprising propeller 1010 driven by river current flow and having a common shaft (unnumbered) with generator 1020. The generator 1020 outputs variable electric power at variable frequency depending on the wind or water flow via cable 1030 to voltage regulator 1040 which receives feed forward from the turbine 1010, 1020 and feedback from the variable load 1070. The voltage regulator 1040 provides a continuously varying control voltage to balance wind or hydrokinetic turbine input against variable load use. The control voltage is provided to motor 1050 which provides constant rotational speed via common shaft 1055 to generator 1060 of motor generator set (MG set) 1050, 1060 for providing a constant electrical frequency to variable load 1070. The motor generator set 1050, 1055, 1060 (MG Set) is powered by a constant voltage from voltage regulator 1040. Generators 1020 and 1060 may be provided in series, in parallel, both in series and in parallel or comprise one or more variable overlap generators.

FIG. 11 (Top View Water and Land) is an example 1100 taken from FIG. 10 where the voltage regulator (VR) 1146 still receives feedback from variable load 1170 but a servo motor 1144 is driven by the voltage regulator sensitive to variable load 1170 for providing a control variable voltage to variable voltage transformer (VVT) 1142 for turning VVT shaft 1152 under control of control brush 1148 to assure a constant electric frequency input for operating motor 1150 of motor generator set: motor 1150, shaft 1155, generator 1160 where common shaft 1155 connects motor 1150 to output generator 1160 for generating constant frequency electricity to variable load 1170. The generated power of generator 1120 is powering motor 1150 through VVT 1142 via cable 1130, and the control power needed for operating servo motor 1144 is minimal. Feed forward voltage is received via cable 1130 and feedback voltage received at voltage regulator 1146 from variable load 1170.

FIG. 12 (Top View Water (and Land)) is an example taken from FIG. 11 showing a power converter 1280 receiving a variable frequency electric power at varying frequency from (a wind or) river flow turbine (shown) comprising propeller 1210 and input electricity generator 1220 connected by common shaft 1215. Power converter 1280 may receive feedforward voltage from input generator 1220 and feedback voltage from its electrical output to variable load 1270. Power converter 1280, variable load 1270 and connections as shown may be land-based.

These and other features of the present invention will be described in the detailed description of the invention and depicted in the accompanying drawings which follows.

### DETAILED DESCRIPTION

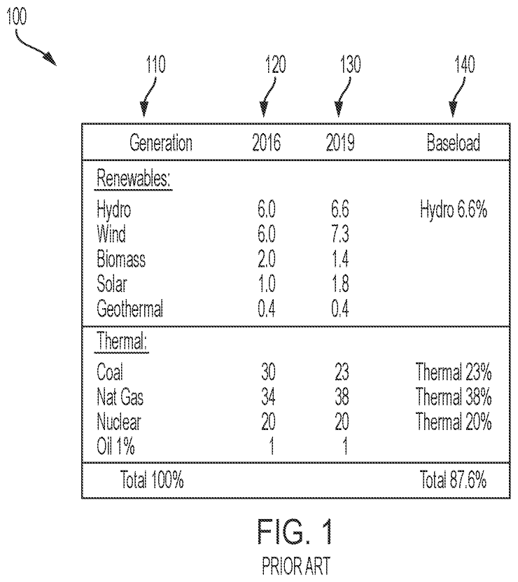

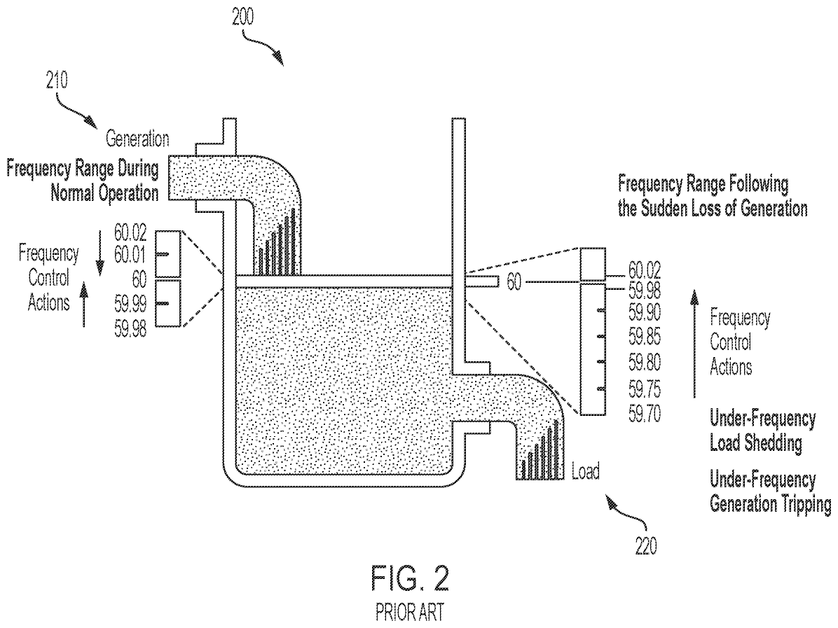

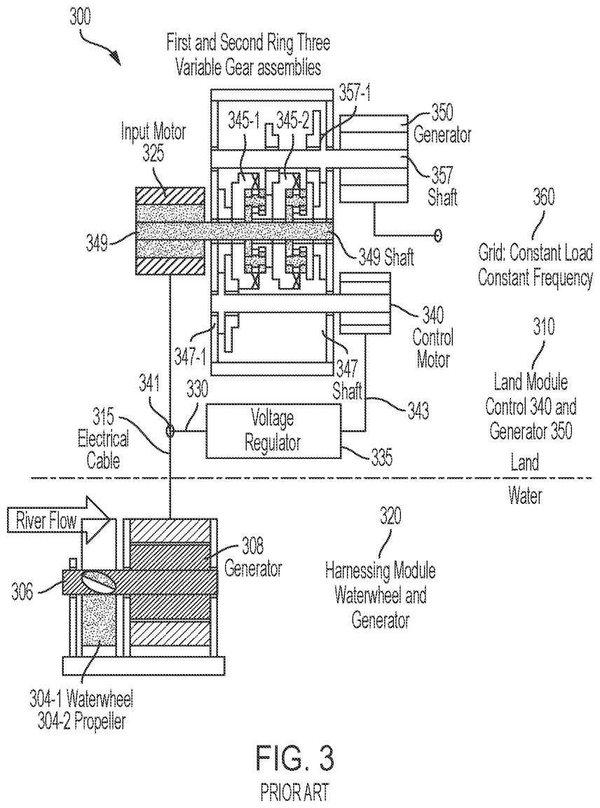

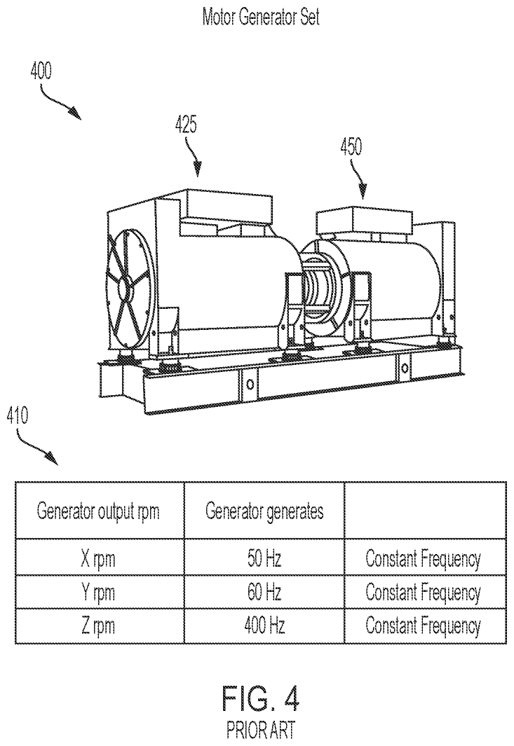

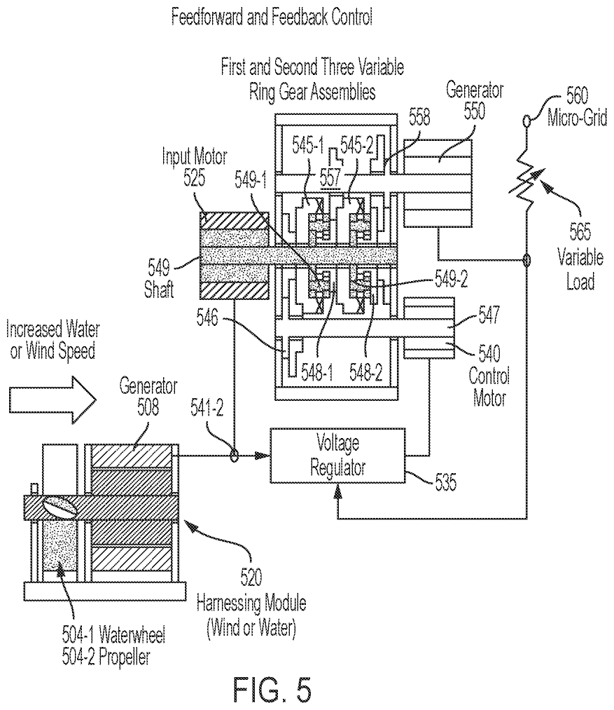

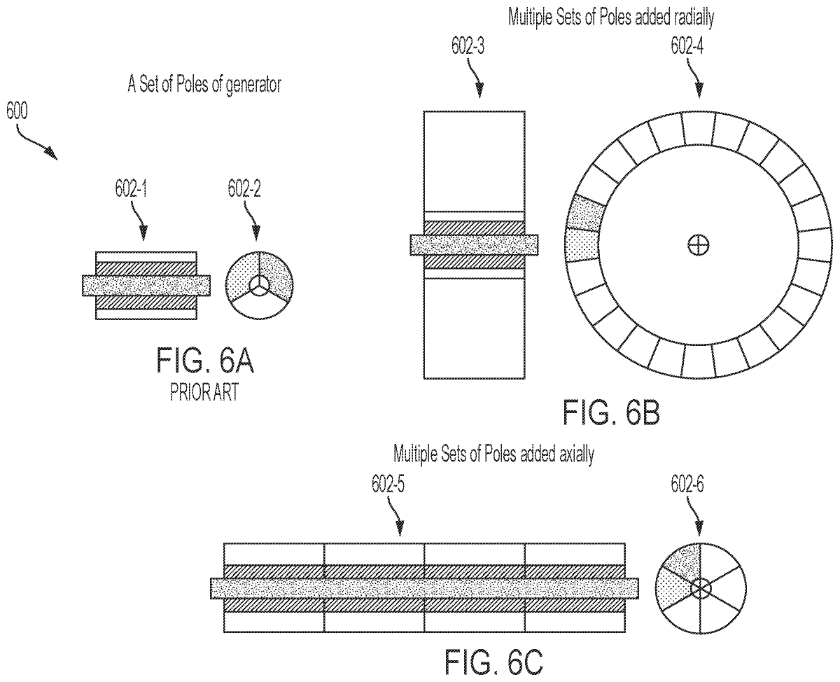

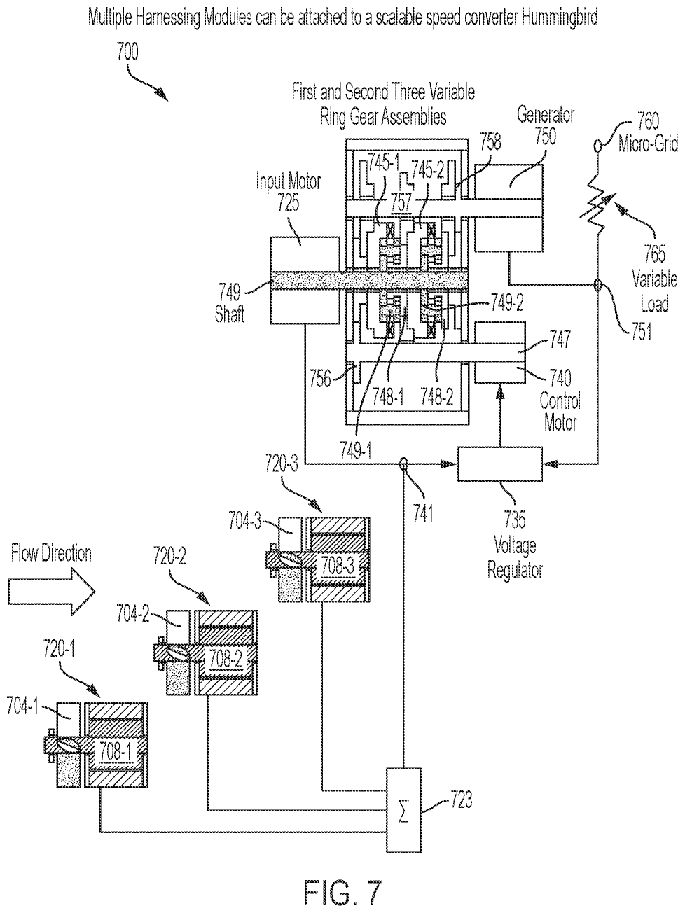

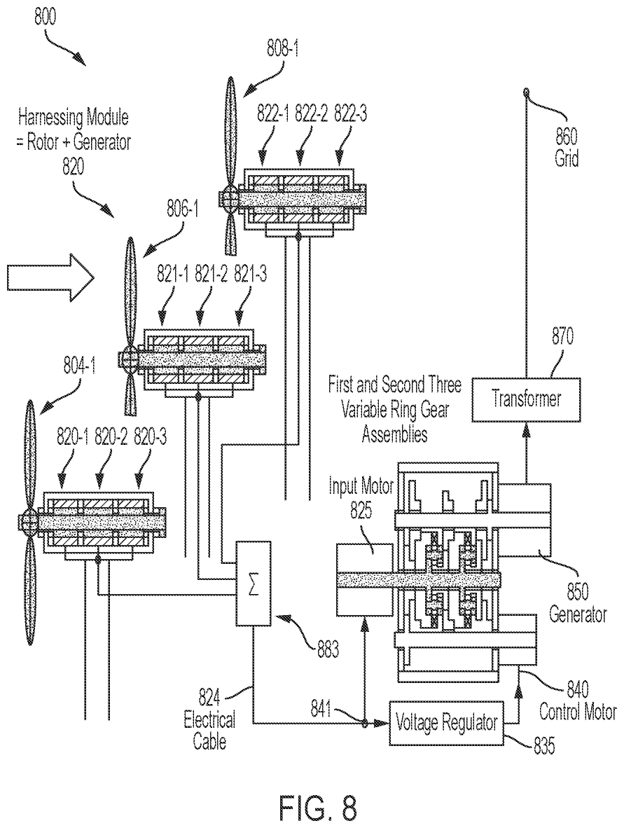

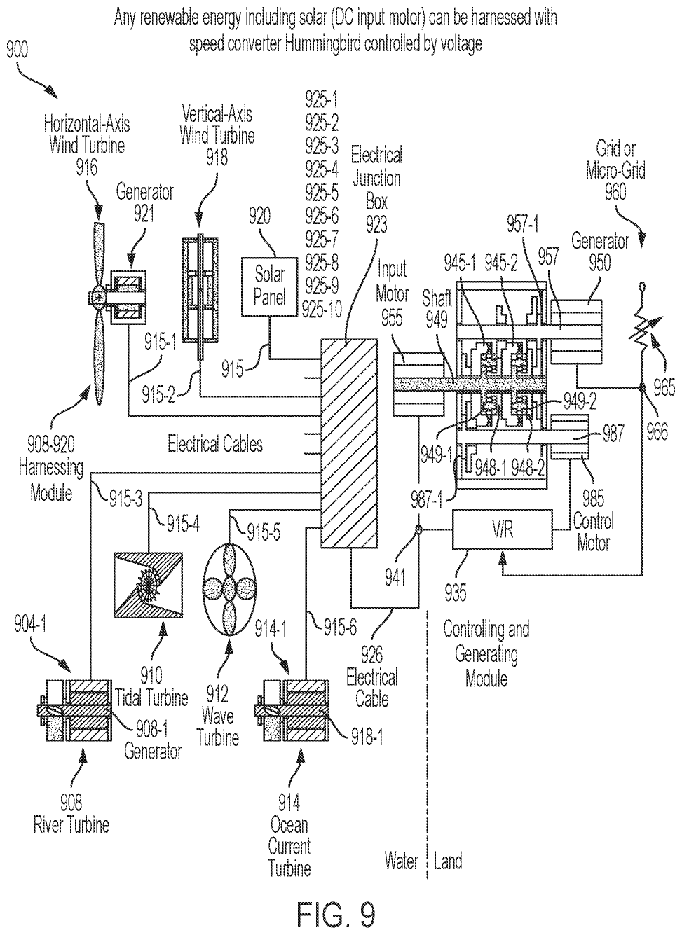

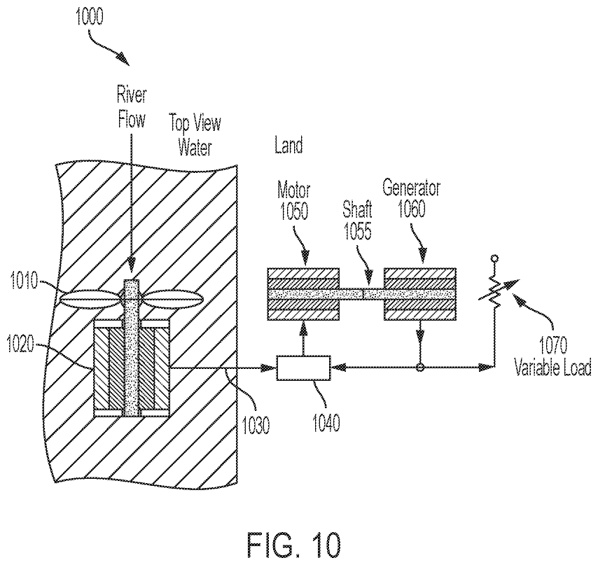

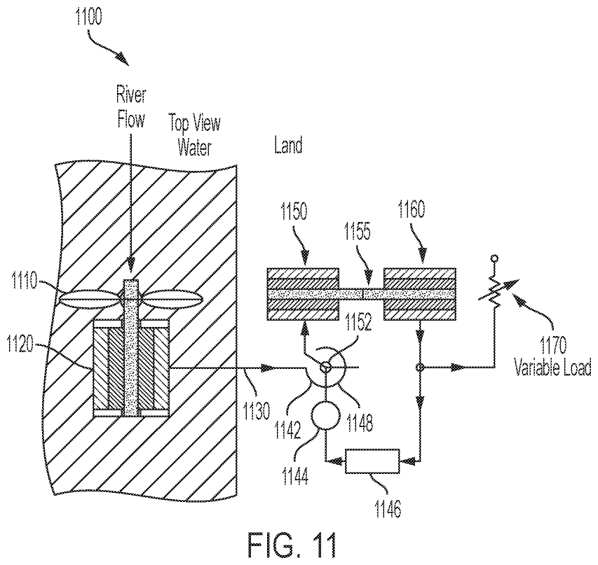

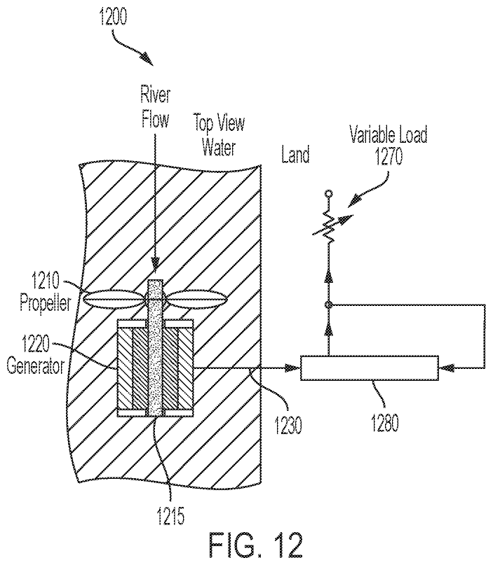

In the figures of the present depicted embodiments comprising prior art FIGS. 1 through 4 and 6A where FIGS. 1 through 4 and 6A show a prior art table, a water to variable electrical load analogy, a known harnessing module and controlling and generating (C&G) module, and a known motor generator set (MG Set) as is known from prior art FIG. 4 and an embodiment of a known generator having a set of three poles (FIG. 6A). FIGS. 5, 6B, 6C, 7, 8, 9, 10, 11 and 12 show nine embodiments of the present invention. The present invention via a feedforward and feedback voltage regulated speed converter providing constant frequency to a variable overlap output generator to a variable load, FIG. 5. The present invention via second and third embodiments, FIGS. 6A and 6B; a fourth embodiment of the present invention, FIG. 7; a fifth embodiment of the present invention, FIG. 8; a sixth embodiment of the present invention, FIG. 9; a seventh embodiment of the present invention, FIG. 10; an eighth embodiment of the present invention, FIG. 11; and a ninth embodiment of the present invention, FIG. 12. An effort has been made herein to follow a convention such that the first reference number for a drawing component such as 1XX indicates a figure number as the first digit where the element first appears; for example, input propeller 310 and input generator 320 driven by propeller 310 first appear in FIG. 4.

FIGS. 1 through 4 and 6A refer to the prior art as discussed above. FIGS. 5, 6B-6C, 7, 8, 9, 10, 11 and 12 provide nine examples of the use of a first embodiment of the present invention comprising a feed forward and a feedback, voltage-regulated speed converter, FIG. 5, and second and third embodiments of the present invention (FIGS. 6B and 6C) showing how multiple sets of multiple poles may be added radially or axially to an output electricity generator of the voltage regulated speed converter of FIG. 5 using a multiple pole generator (FIGS. 6B and 6C); a fourth embodiment of the present invention (FIG. 7) demonstrates an example of adding multiple different energy harnessing modules in series (or parallel) to a voltage regulated speed converter of FIG. 5 of the present invention which may be land-based; a fifth embodiment (FIG. 8) of the present invention describing how a voltage regulated speed converter that may be river or ocean current driven or a land-based module may be added in parallel (or series) to a voltage regulated speed converter of FIG. 5 of the present invention which may be land-based; a sixth embodiment (FIG. 9) of the present invention describing how multiple different types of energy harnessing modules, land or water based, may provide electric capacity in parallel or in series to a voltage regulated speed converter of FIG. 5 of the present invention which may be land-based; an seventh embodiment (FIG. 10) of the present invention showing a top view of one of the many different types of land or water based energy harnessing modules that may be added in series or in parallel to feed a voltage-regulated motor generator set for feeding a variable load at constant frequency; an eighth embodiment (FIG. 11) of the present invention showing a top view of one of the many different types of land or water based energy harnessing modules may be added in series or in parallel to feed a voltage regulator, a servo motor and a variable voltage transformer connected in series for regulating a motor generator set for feeding a variable load at constant frequency; and a ninth embodiment (FIG. 12) of the present invention showing a top view of one of the many different types of land or water based energy harnessing modules may be added in series or in parallel to feed a voltage converter with feedback from a variable load at constant frequency. The present inventions of FIGS. 5, 6B and FIGS. 7 through 12 will now be discussed in detail.

FIG. 5 depicts a first embodiment of a controlling and power generating assembly of the present invention. This first embodiment of the present invention comprising a water or land-based harnessing module 520 wherein the water or wind energy harnessing module 520 typically for wind or water energy involves a propeller 504-2 pointing into the wind using a wind vane or a waterwheel 504-1 pointing in the direction of water flow (concentric wing waterwheel shown). The output of propeller 504-2 or waterwheel 504-1 turning generator 508 is an electrical voltage of variable frequency and variable value depending on the wind or water velocity which may vary as the weather varies. Referring briefly to FIGS. 10 and 11 respectively, when a motor generator set (MG Set) (shown in prior art FIG. 4) is driven by a voltage regulator or a variable voltage, variable frequency feedback value is regulated by a combination in series of a voltage regulator, a servo motor and a variable voltage transformer (VVT), this is a further example of a motor generator set (MG Set) where a voltage regulator 535 samples the value of electric power presently used by the micro-grid (or grid) 560 and may output a control value of voltage to a servo motor (not shown) for turning a control knob shaft of a variable voltage transformer (VVT) not shown. Input to such an alternate voltage regulator arrangement is for automatically turning the shaft of the VVT and carbon brush so it is preset automatically to produce, for example, a constant 60 Hz output frequency at minimum speed. The output of input generator 508 is an electrical voltage of variable frequency and variable value depending on the wind or water velocity which may vary as the weather varies. When a motor generator set (MG Set) (per one of FIGS. 10, 11 and 12) is driven by a variable voltage, variable frequency value and is regulated by a voltage regulator (the voltage regulator will process the full load from the harnessing module and a sample of the grid feedback) having a constant frequency variable power delivered to a load, these are examples of a motor generator set (MG Set) or a voltage converter as will be discussed further herein.

FIGS. 6B and 6C show how the rotational speed converter of FIG. 5 may provide more generation of electrical power via a multiple pole generator 508, 550 having increased poles radially or axially. Referring briefly to FIGS. 10 and 11 respectively, when a motor generator set (MG Set) (shown in prior art FIG. 4) is driven by a voltage regulator or a variable voltage, variable frequency feedback value is regulated by a combination in series of a voltage regulator, a servo motor and a variable voltage transformer (VVT) (not shown), these are further examples of a motor generator set (MG Set) where a voltage regulator 535 samples the value of electric power presently used by the micro-grid (or grid) 560 and outputs a control value of voltage to a servo motor (not shown) for turning a control knob shaft of a variable voltage transformer (VVT). Input is for automatically turning the shaft of the VVT and carbon brush is preset automatically to produce, for example, a constant 60 Hz output frequency at minimum speed. FIGS. 6B (side view) and 6C (cut view) show embodiments of a multiple pole generator 600. Key components of FIG. 6B are that a multiple pole generator may replace generator 508 or 550 such that, for example, eight multiple sets of three poles 602-3 (side view having same height as cut view 602-4) and cut view 602-4 (having a circular shape) may replace one or both generators 508, 550. Key components of FIG. 6C are that, for example, four multiple sets of three poles 602-5 and 602-6 may replace generator 508, 550. There is also (not shown) a combination of FIGS. 6B and 6C where multiple sets of poles may be added both radially and axially to a generator 508 or a generator 550.

FIG. 7 shows a fourth embodiment 700 of the present invention comprising a land-based controlling and power generating module wherein a water flow (shown) or wind flow (not shown) energy harnessing module 720-1 typically for wind flow or water flow energy involves a propeller 704-1 (concentric wing waterwheel shown) pointing into the wind (using a wind vane) or the direction of water flow and electricity generator 708-1 generating variable electricity power at variable frequency. Several, for example, three land or water-based energy harnessing modules 720-1, 720-2 and 720-3 may be combined and their variable electric power at variable electric frequency may be summed at summer 723 and delivered to a speed converter such as one comprising first and second three variable ring gear assemblies (spur or helical and bevel or miter gear assemblies may also be used or substituted and are not shown). The outputs of propellers and waterwheels providing a variable rotational speed for turning, for example, a generator 708-1, -2, -3 is an electrical voltage of variable frequency and variable value (constant X+variable Δ) depending on the wind or water velocity which may vary as the weather varies. Constant electrical frequency output may vary from no rotational speed output of a solar panel to at least double the output rotational speed output of a speed converter or 2X rpm. A voltage converter which will be discussed with reference to FIG. 12 is known as a power converter from the art of wind turbines and converts a variable output of a wind propeller of a vertical or horizontal wind turbine to constant frequency output to a grid. The first and second three variable ring gear assemblies shown comprise a terminal 741 which provides the full variable electric output at variable frequency to input motor 725 having a shaft supporting attached or integral ring gears 745-1 and 745-2 which are components of ring carrier gears 748-1 and 748-2 and 749-1 and 749-2. Terminal 741 also supplies the variable electric output and frequency of summer 723 to voltage regulator 735 which receives a feedback signal of output electricity generator 750 and of variable load 765 to micro-grid 765 which receives the output voltage and constant frequency for delivery to micro-grid (grid) 760. Control motor 740 is the control variable generator which delivers a constant rotational speed via shaft 747 via shaft gear 756 to connect via an intermediate gear to ring gear 745-1 as the control variable. Carrier component gear 748-2 via an intermediate gear connects to shaft gear 758 connected to or integral to generator shaft 757 of electricity generator 750.

FIG. 8 shows an example 800 of a plurality of propeller wind turbines (wind harnessing modules 820 comprising rotors and multiple generators (for example, three generators driven axially) where propeller rotors 804-1, 806-1 and 808-1) where one each of the three generators 820-1, 820-1, 820-3 may be wired to summer 883 and fed to a first and second three variable ring gear assembly (which may be replaced or substituted for by spur or helical, bevel or miter gear assemblies as with FIG. 7). FIG. 8 does not show all the components of first and second three variable ring gear assemblies limiting them to terminal 841, voltage regulator 835, control motor 840 (control variable), 825 (input variable) and generator 850 (output variable). The constant frequency output of generator 850 is delivered by transformer 870 to grid 860 whose variable load voltage may be feedback to voltage regulator 835 as in FIG. 7. Because wind power is intermittent, electric power output is typically sent directly to the grid 860. If other more consistent power is provided by, for example, marine hydrokinetic turbines or thermal or geothermal turbines, then a feedback path to voltage regulator 835 is used as seen in FIG. 7.

FIG. 9 shows a fourth embodiment 900 of the present invention describing how multiple different types of energy harnessing modules (solar modules 920 comprising, for example, ten (10) solar panels 925-1 through 925-10 (land or water based) connected to electrical junction box 923, typically land based, by electrical cables 915-1 through 915-6, along with vertical axis wind turbines (VAWTs) 918 connected by VAWT electrical cable 915-2 and horizontal-axis wind turbine 916 including generator 921 connected by electrical cable 915-1, river turbine harnessing module 908 comprising concentric wing waterwheel 904-1 and generator 908-1 connected by a common shaft wherein generator 908-1 outputs variable electricity at variable frequency to electrical cable 915-3 to electrical junction box 923, tidal turbine 910 connected by electrical cable 915-4 to electrical junction box 923, wave turbine 912 connected by electrical cable 915-5 to electrical junction box 923 and ocean current turbine 914 comprising concentric wing harnessing module 914-1 and generator 918-1 by electric cable 915-6 to electrical junction box 923. Electrical junction box 923 may provide electric capacity via electrical cable 926 in parallel or in series with other electrical junction boxes (not shown) to a voltage regulated mechanical rotational speed converter (first and second ring gear transgears 545-1, 545-2 shown) of FIG. 5 of the present invention which may be land-based. Alternatively, spur or helical gear transgears, bevel or miter gear transgears may be substituted for the ring gear transgears. Terminal 941 of electrical cable 926 provides input electric power at variable frequency to input motor 955 (the input variable) which provides rotational speed at variable frequency to common input shaft 949 of first and second three variable ring gear assemblies 945-1 and 945-2 (which may be spur or helical or bevel or miter gear assemblies in alternate embodiments not shown). Other carrier components comprise carrier components output gear 948-1 of first ring gear transgear 945-1 and planetary gear 949-1. Output carrier gear 949-2 of second ring gear transgear 945-2 meshes with output gear 948-2 which meshes with an intermediate gear to generator shaft gear 957-1 which is combined with or integral output shaft 957 to output electricity generator 950 which delivers electricity at constant frequency as the output variable to variable load 965 and grid or micro-grid 960 via terminal 966. Terminal 966 also provides generator 950 feedback output electricity to voltage regulator 935 for computing the control voltage for control motor 985. Terminal 941 also provides the summed output of electrical junction box (which may be connected to other junction boxes not shown) as a feed forward voltage to voltage regulator 935 and to control motor 985 with a control voltage for output via control shaft 987 to combined or integral control shaft gear for delivering the control rotational speed via an unnumbered gear as control variable to ring gear 945-1.

FIG. 10 shows a top view water of an embodiment 1000 of the present invention wherein a wind alternative to water (river) flow energy harnessing module (water flow harnessing module shown) typically for receiving wind or water energy involves a propeller 1010 pointing into the wind via a wind vane (wind flow) or into the direction of water flow. The output of propeller 1010 turns an electricity generator 1020 outputting on cable 1030 an input electrical voltage of variable frequency and variable value depending on the wind or water velocity which may vary as the weather varies to voltage regulator 1040. When a motor generator set comprising motor 1050, common shaft 1055, and generator 1060 is driven by a variable voltage, variable frequency value and is regulated by a voltage regulator 1040 having a constant frequency variable power delivered to a variable load 1070, this is an example of a motor generator set (MG Set). The voltage regulator 1040 will process the full load from the harnessing module, receives feed forward voltage from river flow harnessing module 1010, 1020 via cable 1030 and receives the grid feedback from variable load 1070 to assure a constant electrical frequency input to motor 1050.

FIG. 11 shows a top view water (and land-based wind alternative (not shown)) of an embodiment 1100 of the present invention comprising a land-based module (including the motor generator set: motor 1150, shaft 1155, generator 1160) wherein a water or wind energy harnessing module (river flow harnessing module shown) typically for wind or water energy involves a propeller 1110 pointing into the wind or the direction of water flow. The output of propeller 1110 turning generator 1120 is an electrical voltage of variable frequency and variable value on electrical cable 1130 depending on the wind or water velocity which may vary as the weather varies as a feed forward voltage to variable voltage transformer 1142. When a motor generator set comprising motor 1150, common shaft 1155 and generator 1160 is driven by a variable voltage, variable frequency value output of river flow harnessing module 1110, 1120 and is regulated via cable 1130 by a combination in series of a voltage regulator 1146, a servo motor 1144 and a variable voltage transformer 1142 having a shaft 1152 and a voltage control brush 1148, this is a further example of a motor generator set where a voltage regulator 1146 receives the value of electric voltage presently used by the grid represented by variable load 1170 as a feedback voltage, Motor generator set 1150, 1155, 1160 outputs voltage at constant frequency to variable load 1170 and outputs a control value of feedback voltage via voltage regulator 1146 to a servo motor 1144 for turning a control shaft 1152 of a variable voltage transformer (VVT) 1142. Input from servo motor 1144 is for automatically turning the shaft 1152 of the VVT 1142 and carbon brush control 1148 so the motor generator set 1150, 1155, 1160 is preset automatically to produce, for example, a constant 60 Hz (US) output frequency.

FIG. 12 shows a top view water of an embodiment 1200 of the present invention comprising a land-based harnessing module or a water-based harnessing module propeller 1210, shaft 1215 and generator 1220 (shown) wherein a water (river flow) (or wind energy harnessing module typically for wind or water energy involves a propeller 1210 pointing into the wind or the direction of water flow. The output of propeller 1210 facing river flow turning generator 1220 via a common shaft 1215 is an electrical voltage of variable frequency and variable value depending on the wind or water velocity which may vary as the weather varies carried by electrical cable 1230 to power converter 1280. A power converter 1280 is known from the art of wind turbines and converts a variable output of a wind/water propeller of a vertical or horizontal wind turbine or river or other turbine to constant frequency output to a variable load 1270. The load 1270 is provides a grid load power value at a given point in time so that the power converter 1280 may adapt a water propeller 1210 rotational speed driving a generator 1220 to output variable power at constant frequency for conversion by the power converter 1280 to output constant frequency to match grid variable load 1270. Feed forward of generator 1220 variable voltage at variable frequency is output by electrical cable 1230 to power converter 1280 and feedback of constant frequency at variable load 1270 is received at power converter 1280.

The principles of application of the several discussed embodiments of a structure and method of constructing same for, for example, providing a green renewable energy alternative to the burning of fuel such as coal, natural gas, oil or other less environmentally friendly energy sources have been demonstrated above. The apparatus comprises a harnessing module specially designed and located on land or in or on water to produce at least a harnessed renewable electrical energy for delivery to a variable load at constant frequency within a confined range, for example, of 60 Hz US±0.02 Hz with feedback from the grid as to load at a given time and feed forward from the harnessing module. Each of the nine-embodiments of the invention automatically provide a constant frequency power output depending on an expected minimum baseload power value from the harnessing module depending on the weather and, for example, in the case of solar energy and changes in the tide, by time of day. The voltage regulator of various embodiments may receive the feedback variable voltage value and the feed forward variable voltage from the harnessing module and generator by one of a motor generator set and a voltage converter received from a variety of renewable energy harnessing modules or thermal sources connected in series or in parallel. The present embodiments used in conjunction with known flow energy turbine systems may or need not be enhanced by using many known control systems for improved operation such as pitch and yaw control in wind turbines adaptable for use as propeller-driven river turbine harnessing modules, control responsive to power grid statistics and remote or automatic control responsive to predicted and actual weather conditions (river velocity from weather forecasts, an anemometer, water flow velocity from a water flow velocity meter, torque control via a torque meter, barometric reading and direction (rising or falling) and the like). These and other features of the invention embodiments discussed above may come to mind from reading the above detailed description, and any claimed invention should be only deemed limited by the scope of the claims to follow. Moreover, the Abstract should not be considered limiting. Any patent applications, issued patents and citations to published articles mentioned herein should be considered incorporated by reference herein in their entirety.

What I claim is:

1. A controlling and power generating assembly for controlling a variable voltage input from at least one energy harnessing module comprising a propeller and an input electricity generator for outputting a minimum variable electric power level at variable frequency as a feed forward electrical value to a voltage regulator of a first and second three variable ring gear, spur or helical gear, bevel or miter gear assembly regulated by the voltage regulator receiving input variable frequency electricity from the at least one energy harnessing module and to an input motor driving an input shaft of the first and second three variable ring gear, spur or helical, bevel or miter gear assembly, the controlling and power generating assembly further comprising:
a control motor for receiving a control voltage as a control variable from the voltage regulator and outputting a constant input rotational speed component (X) to the first three variable ring gear, spur or helical gear, or bevel or miter gear assembly,
the second three variable ring gear, spur or helical gear or bevel or miter gear assembly for outputting a constant output rotational speed component ranging from zero rotational speed to twice the constant input rotational speed component (2X) at constant frequency as an output variable,
the input shaft of the first and second three variable ring gear, spur or helical, bevel or miter gear assembly connected by an output shaft gear of the second three variable ring gear, spur or helical, bevel or miter gear assembly to an output shaft gear of an output shaft to an output electricity generator as an output variable, and
the at least one harnessing module together with the voltage regulator, control motor and input motor actuating an output electric generator to output the constant output rotational speed from zero to twice the constant input rotational component (2X) within a defined range of ±0.02% from 60 Hz.

2. The controlling and power generating assembly for controlling a variable voltage input from at least one energy harnessing module comprising a propeller and an input electricity generator as recited in claim 1, the first and second three variable ring gear, spur or helical, bevel or miter gear assembly being replaced by a motor generator set comprising a generator for outputting a controlled electrical output frequency within a predetermined range of 60 Hz power (US) of ±0.02 Hz wherein the voltage regulator is connected in series with a servo motor for converting a regulated voltage output obtained from the variable load, the servo motor for outputting a rotational speed to the shaft of a variable voltage transformer having a brush control, the variable voltage transformer outputting a constant voltage ranging from zero to twice the constant input rotational speed component (2X) at constant frequency.

3. The controlling and power generating assembly for controlling a variable voltage input from at least one energy harnessing module comprising a propeller and an input electricity generator as recited in claim 2, wherein the first and second three variable ring gear, spur or helical, bevel or miter gear assembly comprise first and second three variable ring gear assemblies.

4. The controlling and power generating assembly for controlling a variable voltage input from at least one energy harnessing module comprising a propeller and an input electricity generator as recited in claim 2, wherein the first and second three variable ring gear, spur or helical, bevel or miter gear assembly comprise first and second three variable spur or helical gear assemblies.

5. The controlling and power generating assembly for controlling a variable voltage input from at least one energy harnessing module comprising a propeller and an input electricity generator as recited in claim 2, wherein the first and second three variable ring gear, spur or helical, bevel or miter gear assembly comprise first and second three variable bevel or miter gear assemblies.

6. A controlling and power generating assembly for controlling a variable voltage input from at least one energy harnessing module comprising a propeller and an input electricity generator for outputting a minimum electric power level at variable frequency as a feed forward electrical value to the controlling and power generating assembly for controlling the variable voltage input from the at least one energy harnessing module comprising the propeller and the input electricity generator for outputting the minimum electric power level at variable frequency as the feed forward electrical value at the variable frequency to a voltage regulator of a first and second three variable ring gear, spur or helical, bevel or miter gear assembly regulated by the voltage regulator receiving input variable frequency electricity from the at least one energy harnessing module, the controlling and generating assembly having an output electricity generator replaced by a generator having multiple sets of poles, the controlling and power generating module comprising:
multiple sets of three poles each added radially to a generator shaft.

7. A controlling and power generating assembly for controlling a variable voltage input from at least one energy harnessing module comprising a propeller and an input electricity generator for outputting a minimum electric power level at variable frequency as a feed forward electrical value at the controlling and power generating assembly for controlling the variable voltage input from the at least one energy harnessing module comprising the propeller and the input electricity generator for outputting the minimum electric power level at variable frequency as the feed forward electrical value at the variable frequency to a voltage regulator of a first and second three variable ring gear, spur or helical, bevel or miter gear assembly regulated by the voltage regulator receiving input variable frequency electricity from the at least one energy harnessing module, the controlling and power generating assembly having an output electricity generator replaced by a generator having multiple sets of poles, the generator having multiple sets of poles comprising:
a multiple set of multiple poles added axially to a generator shaft.

8. A controlling and power generating assembly for controlling a variable voltage input from at least one energy harnessing module comprising a propeller and a generator for outputting a minimum electric power level at variable frequency as a feed forward electrical value at a variable frequency to a voltage regulator of a first and second three variable ring gear, spur or helical, bevel or miter gear assembly regulated by the voltage regulator, the voltage regulator receiving input variable frequency electricity from the at least one energy harnessing module and to an input motor driving a common shaft of the first and second three variable ring gear, spur or helical, bevel or miter gear assembly, the at least one energy harnessing module further comprising:
at least one solar panel for outputting electrical power generated via a photovoltaic converter to an electrical junction box,
the electrical junction box receiving electrical power alternatively from one of a vertical axis wind turbine, a horizontal axis wind turbine, and a river turbine,
the electrical junction box receiving electrical power from one of a wave turbine, an ocean current turbine and a tidal turbine,
the electrical junction box outputting electricity at variable electrical frequency via an electrical cable to the first and second three variable ring gear, spur or helical gear, bevel or miter gear assembly regulated by the voltage regulator, the voltage regulator receiving input variable frequency electricity from the at least one energy harnessing module and outputting the input variable frequency electricity to an input motor driving an input shaft of the first and second three variable ring gear, spur or helical, bevel or miter gear assembly and to the voltage regulator,
a control motor for receiving a control voltage from the voltage regulator and outputting a constant rotational output speed to the first three variable ring gear, spur or helical, or bevel or miter gear assembly, and
the input shaft of the first and second three variable ring gear, spur or helical gear, bevel or miter gear assembly connected by an output gear of the second three variable ring gear, spur or helical, bevel or miter gear assembly connected to an output generator shaft of an output electricity generator within a predetermined frequency range of 60 Hz power (US) of ±0.02 Hz.

9. A controlling and power generating assembly for controlling a variable voltage input from at least one energy harnessing module comprising a propeller rotor and a plurality of electricity input generators for outputting a minimum electric power level at variable frequency as a feed forward electrical value at a variable frequency to a summer for summing at least one minimum electric power level with another minimum electric power level output of the plurality of electricity input generators at the summer, the summer for summing the at least one minimum power level and outputting a summation variable electrical voltage at variable electrical frequency to a voltage regulator of a first and second three variable ring gear, spur or helical, bevel or miter gear assembly regulated by the voltage regulator, the voltage regulator receiving input variable frequency electricity from the at least one energy harnessing module and to an input motor driving a common shaft of the first and second three variable ring gear, spur or helical, bevel or miter gear assembly, the at least one energy harnessing module further comprising:
a propeller rotor connected to an input shaft, the input shaft connected to a plurality of input electricity generators, at least one input electricity generator for outputting an output variable electrical voltage at a constant frequency within a predetermined range of 60 Hz power (US) of ±0.02 Hz to the summer.

10. A controlling and power generating assembly for controlling a variable voltage input from at least one energy harnessing module, the at least one energy harnessing module comprising a renewable energy harnessing module, the renewable energy harnessing module comprising a propeller rotor and a plurality of electricity input generators for outputting a minimum electric power level at variable frequency as a feed forward electrical value at a variable frequency to a summer for summing at least one minimum electric power level with another minimum electric power level output of the plurality of electricity input generators at the summer according to claim 9, the summer for additionally summing a thermal source of power comprising one of a coal source, a natural gas source, a nuclear source and an oil source of electrical energy.

11. A controlling and power generating assembly for controlling a variable voltage input from at least one harnessing module and feedback variable voltage from a variable load, the controlling and power generating assembly utilizing a feedback voltage from the variable load at a voltage regulator coupled to a motor generator set to automatically control delivery of power to the variable load such that an output of the controlling and power generating assembly provides an optimum variable electric energy power to the constantly varying grid load in excess of a predetermined minimum value, the controlling and power generating assembly for outputting a variable value of electric energy power to the variable load at constant electric frequency, the controlling and power generating assembly comprising:
a voltage regulator for receiving variable electric power at variable frequency in excess of a predetermined minimum value from the at least one harnessing module, the voltage regulator for outputting a control voltage to a motor generator set, the voltage regulator connected to a variable grid load varying constantly, and
the motor generator set outputting the optimum variable of electric energy power to the constantly varying grid load at constant electrical frequency within a predetermined range of 60 Hz power (US) of ±0.02 Hz.

12. A controlling and power generating assembly for controlling a variable voltage input from at least one harnessing module and feedback variable voltage from a variable load, the controlling and power generating assembly utilizing a feedback voltage from the variable load at a voltage regulator coupled to a motor generator set, the voltage regulator connected to automatically control delivery of power to the variable load such that an output of the controlling and power generating assembly provides an optimum variable electric energy power to the constantly varying grid load in excess of a predetermined minimum value, the controlling and power generating assembly for outputting a variable value of electric energy power to the variable load at constant electric frequency, the controlling and power generating assembly comprising:
a voltage regulator connected in series to a servo motor, the voltage regulator for receiving a feedback power level from the constantly varying grid load,
the servo motor, responsive to the voltage regulator, for outputting a rotational input to a control knob shaft of a variable voltage transformer, and
the variable voltage transformer for receiving variable electric power at variable frequency in excess of a predetermined minimum value from the at least one harnessing module and for outputting at least the predetermined minimum value to the motor generator set, and
the motor generator set outputting the output variable of electric energy power within a predetermined range of 60 Hz power (US) of ±0.02 Hz.

13. The controlling and power generating assembly for controlling a variable voltage input from at least one harnessing module and feedback variable voltage from a variable load, the controlling and power generating assembly utilizing a feedback voltage from the variable load at a voltage regulator coupled to a motor generator set as recited in claim 12,
the voltage regulator further connected in series to a servo motor and the servo motor connected in series to a variable voltage transformer, the variable voltage transformer for receiving the variable electric power at the variable frequency in excess of a predetermined minimum value from the at least one harnessing module and for outputting at least the predetermined minimum value to the motor generator set, and
the motor generator set outputting the output variable of electric energy power to the constantly varying grid load within a predetermined range of 60 Hz power (US) of ±0.02 Hz.

14. A controlling and power generating assembly for controlling a variable voltage input from at least one harnessing module and feedback variable voltage from a variable load, the controlling and power generating assembly utilizing a feedback voltage from the variable load at a power converter, the controlling and power generating assembly comprising:
a harnessing module comprising a propeller and a generator outputting variable electric power at varying frequency in excess of a predetermined minimum value, and
a power converter for receiving the output variable electric power at varying frequency and receiving a feedback voltage from a grid load at varying load at a continuously changing point in time, the power converter outputting the output variable electric power at constant frequency within a predetermined range of 60 Hz power (US) of ±0.02 Hz to the grid load at varying load.
